(19) United States
(12) Patent Application Publication
(10) Pub. No.: US 2014/0284327 A1
(43) Pub. Date: Sep. 25, 2014

(54) TOTE ASSEMBLY AND METHODS OF USE

(71) Applicant: Keith Worley, Decatur, GA (US)

(72) Inventor: Keith Worley, Decatur, GA (US)

(21) Appl. No.: 13/917,106

(22) Filed: Jun. 13, 2013

Related U.S. Application Data
(60) Provisional application No. 61/815,777, filed on Apr. 25, 2013.
(60) Provisional application No. 61/804,663, filed on Mar. 23, 2013.
(60) Provisional application No. 61/806,871, filed on Mar. 30, 2013.

(51) Int. Cl. B65F 1/00; B65B 7/16

(52) U.S. Cl. CPC B65F 1/0006; B65B 7/16
USPC 220/4.24; 53/467

(57) ABSTRACT

A tote assembly and methods of use including, in general, a bag or tote configured with two or more sides fastened together to form two or more edges, wherein at least one edge is curved or arcing, one or more straps configured to center contents or load therein and, thus to enable a single person to lift, maneuver, transport, and remove a decommissioned toilet bowl from a premise without causing injury.

### CROSS REFERENCE TO RELATED APPLICATIONS

To the full extent permitted by law, the present United States Non-Provisional patent application claims priority to and the full benefit of United States Provisional patent application entitled “Toilet Bowl Removal Device and Method”, filed on Apr. 25, 2013, having assigned Ser. No. 61/815,777; United States Provisional patent application entitled “Toilet Removal Apparatus and Method”, filed on Mar. 23, 2013, having assigned Ser. No. 61/804,663; and United States Provisional patent application entitled “Wheeled Toilet Bowl Removal Device and Method”, filed on Mar. 30, 2013, having assigned Ser. No. 61/806,871, incorporated entirely herein by reference.

### TECHNICAL FIELD

The disclosure relates generally to bag or tote for removal of construction debris and more specifically it relates to safe and clean removal of a decommissioned toilet from a residence or business.

### BACKGROUND

Various totes, bags, and packs are known in the prior art, for example, there are totes, bags, and packs for special purposes, such as reusable grocery bags used to transport grocery items from the merchant to your car and into your home. Reusable shopping bags are a type of shopping bag which can be reused several times as an alternative of single use paper or plastic bags. Reusable shopping bags are constructed of fabric such as canvas, woven synthetic fibers, or a thick plastic and have two loop support straps sewn to the bag side to assist with lifting and transporting grocery items.

Moreover, a variety of carts, trucks, and dollies exist for lifting and transporting various heavy, unique, or awkwardly shaped items. Most such carts, trucks, and dollies include structure, wheels, a platform and some leverage or lift device to either lift or tilt the heavy, unique, or awkwardly shaped items to aid in lifting and transporting such items. Prior art devices have been devised to mechanically lift and roll a toilet away from the toilet foundation. However, the prior art devices suffer from several deficiencies. For instance, prior art lifting devices are bulky and cumbersome to maneuver in bathrooms, hallways, up or down a flight of steps, and exit points to homes, apartments, and businesses.

In the course of remodeling or servicing homes, apartments, buildings, and businesses, contractors and other maintenance personnel, such as plumbers, find it necessary to remove toilets in order to install new toilet fixtures. Toilets are heavy, bulky, and generally awkward to lift, transport, and lower and in general toilets are undesirable to touch and lift with ones arms and hands. Moreover, ceramic toilet units are slippery when wet and may be easily damaged or break into shards if dropped. In many cases two people are required to safely remove a toilet from a building.

Additionally, it can be difficult to remove the existing water contained in the tank and bowl, so as to not spill water and or contaminants when carrying the toilet out of homes, apartments, buildings, and businesses. In an attempt to fully remove the contaminated water from the bowl many plumbers use portable wet/dry vacuums to remove the water, but generally one is unable to remove all of the water and spillage often occurs. Furthermore, carrying a wet/dry vacuum containing water and contaminants is not without its own risks. Moreover if a decommissioned toilet is dropped it may result in wet shards of broken ceramic and wet surface areas, which may result in injury to an installer and represents a slip hazard for restroom patrons. Furthermore, the manual maneuvering of the typical toilet unit by plumbers or an installer during removal of the decommissioned toilet may result in painful and costly back injuries.

Lastly, if a plumber has been called to remove a toilet it is usually because it has not been working properly and in many cases it can be quite soiled. This requires the plumber to either clean the toilet before beginning the removal process, or simply tolerate the unpleasantness that can often accompany removing and transporting the soiled decommissioned toilet.

Therefore, it is readily apparent that there is a recognizable unmet need for a tote assembly and methods of use, wherein such assembly may be utilized to enclose uniquely and awkwardly shaped toilet bowl having some water and/or contaminants held therein and safely and cleanly lift, maneuver, transport, and remove a decommissioned toilet bowl from homes, apartments, buildings, and businesses without spilling the contents of the bowl, causing injury while enabling efficient, fast, sanitary, and dependable maneuverability of the toilet in bathrooms, hallways, up or down a flight of steps, and exit points.

### BRIEF SUMMARY

Briefly described, in example embodiment, the present apparatus overcomes the above-mentioned disadvantage, and meets the recognized need for a tote assembly and methods of use comprising, in general, a bag or tote configured with two or more sides fastened together to form two or more edges, wherein at least one edge is curved or arcing, one or more straps configured to center contents or load therein and, thus to enable a single person to lift, maneuver, transport, and remove a decommissioned toilet bowl from a premise without causing injury.

In a preferred embodiment, a tote assembly to remove a decommissioned curved article holding fluid therein from a premise, the assembly including one or more layers having one or more edges, wherein one or more edges form an opening and wherein the one or more layers and the opening form an interior space, and wherein at least one of the one or more edges is further configured as an arc to match the curvature of the decommissioned curved article holding fluid therein, one or more lift devices disposed proximate the one or more layers and configured to transport the tote assembly from the premise, and one or more constricting straps disposed proximate the one or more edges and configured to cinch decommissioned curved article.

In a further exemplary embodiment, a tote assembly to remove a decommissioned curved article holding fluid herein from a premise, the assembly including one or more layers, the one or more layers having a front layer and a back layer, wherein the front layer and the back layer further comprise one or more edges to form an opening and wherein the one or more layers and the opening form an interior space, and wherein at least one of the one or more edges is further configured as an arc to match the curvature of the decommissioned curved article holding fluid therein, one or more lift devices disposed proximate the one or more layers and configured to transport the tote assembly from the premise, the one or more lift devices further comprises one or more loop straps, and one or more constricting straps disposed proximate the one or more edges and configured to cinch decommissioned curved article, the one or more constricting straps configured to distribute decommissioned curved article therebetween the one or more edges.

In still a further exemplary embodiment of the method of removing a decommissioned curved article holding fluid therein from a premise, including the steps of providing a tote assembly having one or more layers, the one or more layers having a front layer and a back layer, wherein the front layer and the back layer further comprise one or more edges to form an opening and wherein the one or more layers and the opening form an interior space, and wherein at least one of said one or more edges is further configured as an arc to match the curvature of the decommissioned curved article holding fluid therein, one or more lift devices disposed proximate the one or more layers and configured to transport the tote assembly from the premise, the one or more lift devices further comprises one or more loop straps, and one or more constricting straps disposed proximate the one or more edges and configured to cinch decommissioned curved article, the one or more constricting straps configured to distribute decommissioned curved article therebetween the one or more edges, spreading open the opening, inverting the opening up-side-down, covering the decommissioned curved article holding fluid therein, sliding the at least one of the one or more edges configured as an arc against the decommissioned curved article holding fluid therein, and rolling the tote assembly and the decommissioned curved article holding fluid therein toward the at least one of the one or more edges configured as an arc until the opening is right-side-up.

Accordingly, a feature of the tote assembly and methods of use is its ability to provide a tote configured to not spill water and/or contaminants when lifting, carrying, transporting or maneuvering the toilet out of homes, apartments, buildings, or businesses.

Another feature of the tote assembly and methods of use is its ability to provide efficient and safe lifting and transporting of various heavy, slippery, unique or awkwardly shaped items.

Still another feature of the tote assembly and methods of use is its ability to enable a single person to lift, maneuver, transport, and remove a decommissioned toilet bowl from homes, apartments, buildings, and businesses without spilling the contents of the bowl or causing injury.

Yet another feature of the tote assembly and methods of use is its ability to eliminate the need to carry a portable wet/dry vacuum to the toilet site to remove water and/or contaminants from the toilet.

Yet another feature of the tote assembly and methods of use is its ability to reduce dropping the decommissioned toilet preventing wet shards of broken ceramic and wet surface areas, which may result in injury to an installer and represents a slip hazard for restroom patrons.

Yet another feature of the tote assembly and methods of use is its ability to reduce painful and costly back injuries due to lifting and transporting heavy, slippery, unique or awkwardly shaped items, such as decommissioned toilet bowls. For example, to remove decommissioned toilet bowl a service person must bend over and lift the entire load from the ground up using one's arms and back without the aid of handles.

Yet another feature of the tote assembly and methods of use is its ability to provide a foldable tote or bag that is easily stored and transported to the work site.

Yet another feature of the tote assembly and methods of use is its ability to keep the bowl balanced and level during lifting, carrying, transporting, or maneuvering the toilet out of homes, apartments, buildings, or businesses.

Yet another feature of the tote assembly and methods of use is its ability to keep the bag or tote sealed during lifting, carrying, transporting, or maneuvering the toilet out of homes, apartments, buildings, or businesses.

Yet another feature of the tote assembly and methods of use is its ability to accommodate curved and arcing configuration of toilet bowls.

Yet another feature of the tote assembly and methods of use is its ability to enable quick and efficient removal of a decommissioned toilet from homes, apartments, buildings, or businesses.

These and other features of the tote assembly and methods of use will become more apparent to one skilled in the art from the following Detailed Description of the Embodiments and Claims when read in light of the accompanying drawing Figures.

### BRIEF DESCRIPTION OF THE DRAWINGS

The present tote assembly and methods of use will be better understood by reading the Detailed Description of the embodiments with reference to the accompanying drawing figures, in which like reference numerals denote similar structure and refer to like elements throughout, and in which:

FIG. 1 is a perspective view of an example embodiment of toilet tote assembly;

FIG. 2 is a perspective view of an alternate example embodiment of tote assembly of FIG. 1;

FIG. 3 is a side perspective view of a floor seated toilet of FIG. 3;

FIG. 4 is a perspective view of the tote assembly of FIG. 1 rotated approximately 130 degrees and shown positioned above floor seated toilet of FIG. 3;

FIGS. 5A and 5B is a side view of the tote assembly of FIG. 1 shown inverted and positioned to cover the floor seated toilet of FIG. 3;

FIG. 6 is a side view of the tote assembly of FIG. 1 shown inverted and positioned to cover the floor seated toilet of FIG. 3, with toilet being rolled into the tote, shown with tote and toilet rotated approximately forty-five degrees;

FIG. 7 is a side view of the tote assembly of FIG. 1 shown inverted and positioned to cover the floor seated toilet of FIG. 3, with toilet being rolled into the tote, shown with tote and toilet rotated approximately ninety degrees;

FIG. 8 is a side view of the tote assembly of FIG. 1 shown inverted and positioned to cover the floor seated toilet of FIG. 3, with toilet being rolled into the tote, shown with tote and toilet inverted or rotated approximately one hundred and eighty degrees;

FIG. 9 is a side view of the floor seated toilet of FIG. 3, with tote assembly of FIG. 1 shown sealed, centered, and secured therein toilet tote assembly;

FIG. 10A is a flow diagram of a method of covering, rolling, securing, lifting, carrying, transporting, and maneuvering the floor seated toilet of FIG. 3 utilizing the tote assembly of FIG. 1 out of homes, apartments, buildings, or businesses (premise); and

FIG. 10B is a continued flow diagram of FIG. 10A a method of covering, rolling, securing, lifting, carrying, transporting, and maneuvering the floor seated toilet of FIG. 3 utilizing the tote assembly of FIG. 1 out of homes, apartments, buildings, or businesses (premise).

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

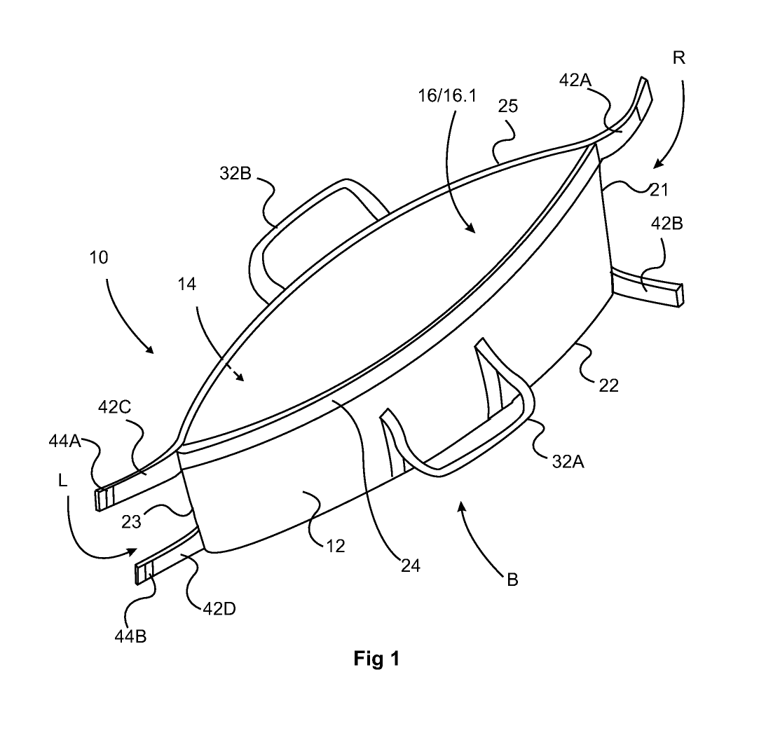

In describing the exemplary embodiments of the present disclosure, as illustrated in FIGS. 1-10 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

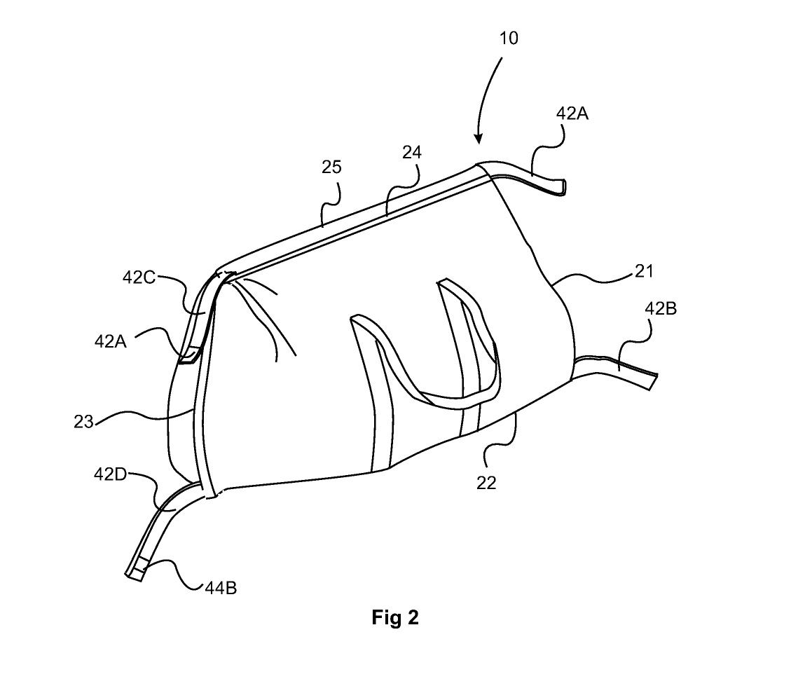

Referring now to FIGS. 1 and 2, by way of example, and not limitation, there are illustrated exemplary embodiments of tote assembly 10. Preferably, tote assembly 10 includes one or more sides or layers, such as front side or front layer 12 and back side or back layer 14. Sides, such as front layer 12 and back layer 14 preferably include one or more edges, such as first edge 21, second edge 22, third edge 23, fourth edge 24, and fifth edge 25. On one first side or right side R of front layer 12 and back layer 14 are preferably joined, bonded, sewn, or otherwise affixed along first edge 21 to form a sealed fluid or water tight seam, sealing mechanism, along first edge 21 between front layer 12 and back layer 14. It is contemplated herein that front layer 12 and back layer 14 may include one continuous layer. On one other or second side or left side L of front layer 12 and back layer 14 are preferably joined, bonded, sewn, or otherwise affixed along third edge 23 to form a sealed water tight seam along third edge 23 between front layer 12 and back layer 14. On one bottom side B or third side of front layer 12 and back layer 14 are preferably joined, bonded, sewn, or otherwise affixed along second edge 22 to form a sealed water tight seam along second edge 22 between front layer 12 and back layer 14. It is recognized herein that front layer 12 and back layer 14 and first edge 21, second edge 22, and third edge are configured to form a container, bag, sack or the like preferably configured with an opening, such as opening formed by fourth edge 24 of front layer 12 and fifth edge 25 of back layer 14. Preferably opening 16 extends from first edge 21 to second edge 22 of front layer 12 and back layer 14. It is contemplated herein that opening 16 may partially extend between first edge 21 and second edge 22 to form a smaller opening, wherein a portion of fourth edge 24 of front layer 12 and fifth edge 25 of back layer may be joined, bonded, sewn, or otherwise affixed between fourth edge 24 and fifth edge 25 to form a sealed water tight seam between fourth edge 24 and fifth edge 25. It is further contemplated herein that opening 16 may be sized to required dimension to accommodate the content(s) or article(s) to be contained therein tote assembly 10. It is further contemplated herein that opening 16 and one or more sides or layers, such as front layer 12 and back layer 14 form interior space 16.1.

Preferably second edge 22 is longer or greater in length than fourth edge 24 and fifth edge 25 to form angled, curved, tapered, or arced first edge 21 and/or third edge 23 of front layer 12 and back layer 14. It is contemplated herein that angled, curved, or arced first edge 21 and/or third edge 23 is preferably configured to match or fit the curvature of a curved object contained therein tote assembly 10. It is still further contemplated herein that angled, curved, or arced first edge 21 and/or third edge 23 preferably prevent the spillage of fluid therefrom tote assembly 10. It is still further contemplated herein that angled, curved, or arced first edge 21 and/or third edge 23 preferably provides a raised portion or section to first edge 21 and/or third edge 23 and when tote assembly 10 is rotated fluid will be contained therein tote assembly 10. Moreover, it is contemplated herein that second edge 22 may form bottom side B and front layer 12 and back layer 14 may be continuous without any edge, such as a cylinder, or duffle or draw string style bag.

Furthermore, tote assembly 10 preferably includes one or more carrying or lift devices, straps, handles, or lift points, such as loop strap or continuous loop strap 32 preferably configured to assist a user with carrying tote assembly 10. Preferably continuous loop straps 32 include front loop strap 32A positioned proximate front layer 12 or affixed thereto front layer 12 or positioned proximate back layer 14 or affixed thereto back layer 14. Front loop strap 32A and back loop strap 32B are preferably configured to depart or enable heavy lifting strength of tote assembly 10 and assist a user with carrying tote assembly 10. Moreover, front loop strap 32A and back loop strap 32B are preferably center positioned on front layer 12 and back layer 14 to evenly distribute the contents or load of tote assembly 10 across loop strap 32A and back loop strap 32B. Furthermore, front loop strap 32A and back loop strap 32B preferably extend above fourth edge 24 and fifth edge 25 once fourth edge 24 and fifth edge 25 have been rolled to seal opening 16 to enable ease to grasp front loop strap 32A and back loop strap 32B.

Still further, tote assembly 10 includes one or more cinch or constricting devices, such as constricting straps 42 are preferably configured to assist a user with sealing opening 16 and/or centering the contents or load therein tote assembly 10 or therebetween loop strap 32A and back loop strap 32B. Preferably constricting straps 42 includes first constricting strap 42A, second constricting strap 42B, third constricting straps 42C, and fourth constricting strap 42D.

Preferably second constricting strap 42B and fourth constricting strap 42D are positioned proximate front layer or affixed thereto front layer 12 or positioned proximate back layer 14 or affixed thereto back layer 14 and positioned proximate second edge 22 or bottom side B, or alternatively positioned midway between second edge 22 and fourth edge 24 or fifth edge 25. Preferably second constricting strap 42B and fourth constricting strap 42D are preferably configured to cinch or constrict the contents or load of tote assembly 10 and position the contents of tote assembly 10 between front loop strap 32A and back loop strap 32B or to center the load or contents of tote assembly 10 between first edge 21 and third edge 23 so as to evenly distribute or sandwich the contents or load of tote assembly 10.

Preferably first constricting strap 42A and third constricting straps 42C are positioned proximate front layer 12 or affixed thereto front layer 12 or positioned proximate back layer 14 or affixed thereto back layer 14 or alternatively positioned midway between second edge 22 and fourth edge 24 or fifth edge 25. Preferably first constricting strap 42A and third constricting straps 42C are preferably configured to cinch or constrict fourth edge 24 and fifth edge 25 preferably after rolling fourth edge 24 and fifth edge 25 to seal or create a water tight seam between fourth edge 24 and fifth edge 25 of tote assembly 10. It is contemplated herein that fourth edge 24 and fifth edge 25 may be stiffened by sewing an object therein rolled fourth edge 24 and fifth edge 25 or even by sewing rolled fourth edge 24 and fifth edge 25 to create a stiffened edge outlining opening 16. Then repeated folded or rolled fourth edge 24 and fifth edge 25 creates a seal or water tight seam, sealing mechanism, between fourth edge 24 and fifth edge 25. It is further contemplated herein that other sealing mechanism to seal or create a water tight seam between fourth edge 24 and fifth edge 25 of tote assembly 10 known to one of ordinary skill in the art such as, zip lock, hook and loop, zipper, peel and stick and the like.

Tote assembly 10 sides, layers, and straps are preferably formed of a vinyl, suitable material or fabric, such as vinyl, canvas, plastic, rubber, polyurethane, fiber, coated fiber or mesh, nylon, Tyvek, or the like, capable of providing structure to tote assembly 10. Preferably, the material includes other suitable characteristics, such as flexibility, durability, water resistant, seal fluids therein, puncture resistant, tear resistant, rust-resistance, light weight, heat-resistance, chemical inertness, oxidation resistance, ease of workability, or other beneficial characteristic understood by one skilled in the art.

Preferably one or more of first constricting strap 42A, second constricting strap 42B, third constricting straps 42C, and/or fourth constricting strap 42D includes an attachment mechanism 44 to affix together two such straps, such as first attachment mechanism 44A configured to preferably affix first constricting strap 42A and third constricting straps 42C together. Second attachment mechanism 44B configured to preferably affix second constricting strap 42B and fourth constricting strap 42D together. It is contemplated herein that attachment mechanism 44 may include a buckle, cinch device, hook and loop, peel and stick and the like. It is further contemplated herein that constricting straps and buckle may be utilized to cinch or constrict tote assembly 10. It is still further contemplated herein that constricting straps 42 may affix to front layer 12 and back layer 14, such as by hook and loop or peel and stick.

It is further contemplated herein that tote assembly 10 or opening 16 may be configured and/or sized to accommodate various objects to be contained therein.

It is further contemplated herein that tote assembly 10 may be designed for single disposable use or re-useable for multiple uses.

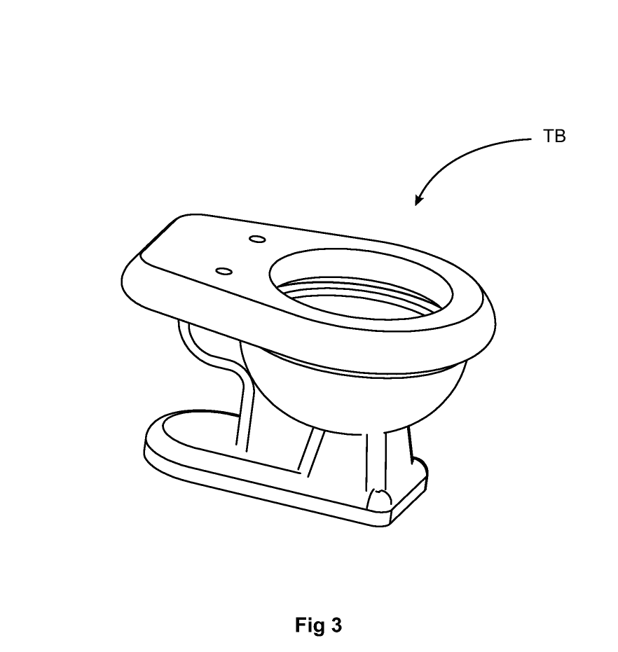

Referring now to FIG. 3, by way of example, and not limitation, there is illustrated exemplary floor seated toilet bowl TB. It is contemplated herein that toilet bowl TB may include object(s), decommissioned articles, appliance(s), article(s), discontinued construction material(s) or the like having residual water or other fluid, such as toilet bowl water W contained therein that a service person does not want spilled in the work site or along the path transporting such item outside the work site.

Referring now to FIG. 4, by way of example, and not limitation, there is illustrated exemplary floor seated toilet bowl TB of FIG. 3 with tote assembly 10 of FIG. 1 shown positioned above floor seated toilet TB. Preferably tote assembly 10 is rotated (rotation) R approximately 130 to 180 degrees, wherein opening 16 is preferably positioned with opening 16 directed downward and opening 16 is preferably disposed above floor seated toilet TB with opening 16 spread wide open.

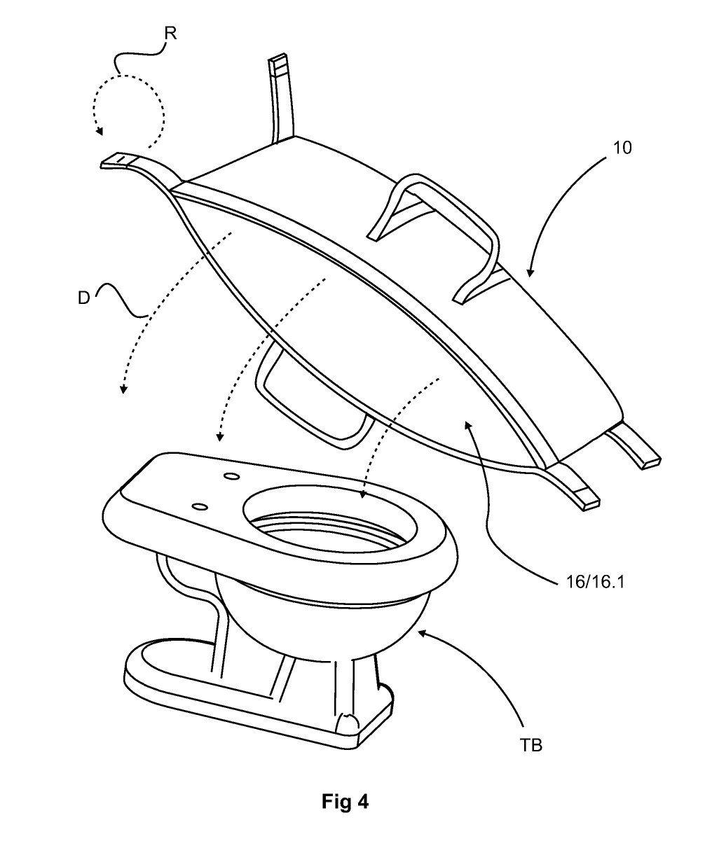

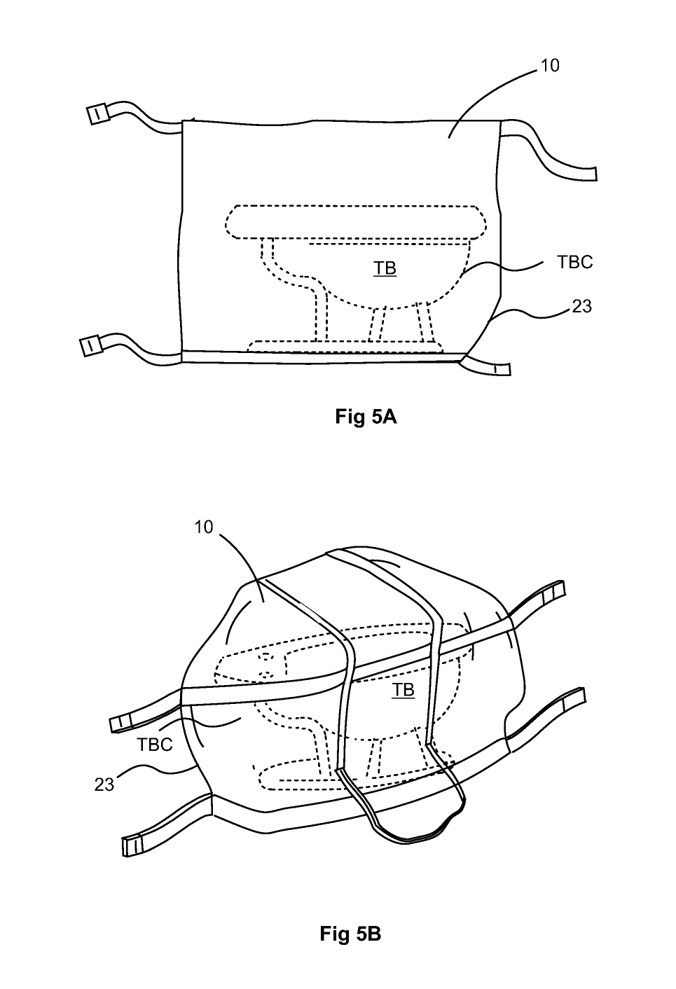

Referring now to FIGS. 5A and 5B, by way of example, and not limitation, there is illustrated exemplary and alternate tote assembly 10 of FIG. 1 and FIG. 2 shown inverted and positioned to cover the floor seated toilet TB. Preferably opening 16 of tote assembly 10 is spread open and tote assembly 10 is inserted in, slid over, positioned on, or placed on floor seated toilet TB to surround or cover floor seated toilet TB. Moreover, third edge 23 of tote assembly 10 is preferably slid up against or disposed in close proximity to a curved object contained therein tote assembly 10, such as toilet bowl curvature TBC of floor seated toilet bowl TB. It is contemplated herein that third edge 23 of tote assembly 10 is preferably configured to match the curvature of a curved object contained therein tote assembly 10. It is further contemplated herein that tote assembly 10 may be utilized to cover other object(s), appliance(s), article(s), discontinued construction material(s) or the like.

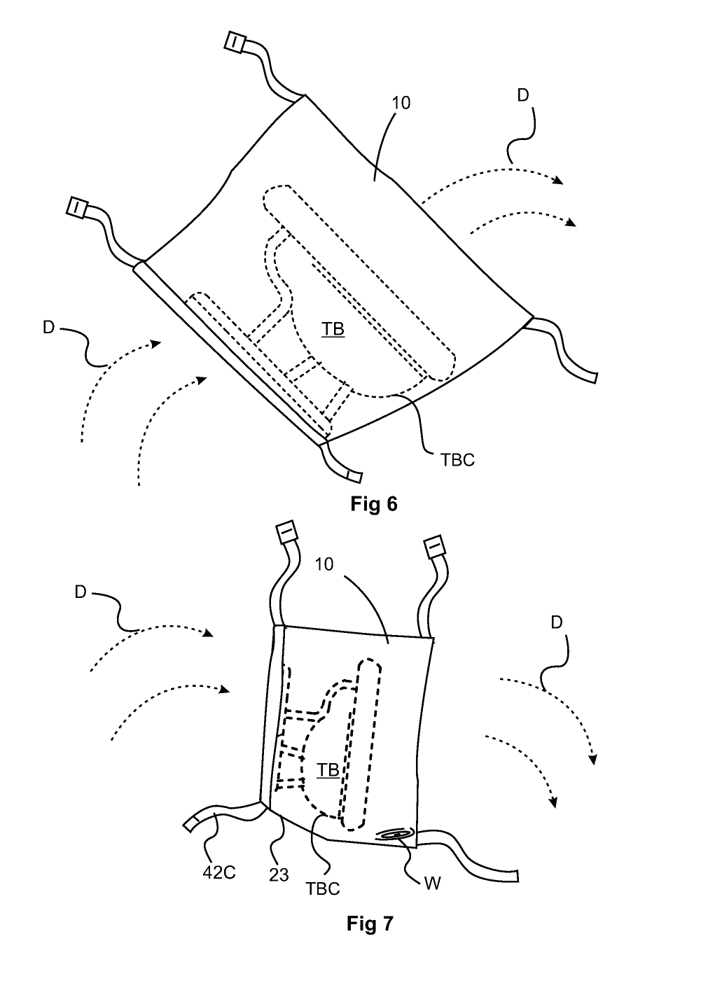

Referring now to FIG. 6, by way of example, and not limitation, there is illustrated exemplary tote assembly 10 shown inverted and positioned to cover floor seated toilet TB. Preferably floor seated toilet TB and tote assembly 10 are pushed, rolled, rotated or pulled in the direction D to have floor seated toilet TB roll into or with tote assembly 10, shown with tote and toilet rotated R approximately forty-five degrees. Moreover, grasping the back of floor seated toilet TB, pulling floor seated toilet TB forward, breaking the wax seal while maintaining contact between the front corner or toilet bowl curve TBC and the floor so as to support floor seated toilet TB.

Referring now to FIG. 7, by way of example, and not limitation, there is illustrated exemplary tote assembly 10 shown with floor seated toilet TB positioned therein. Preferably floor seated toilet TB and tote assembly 10 are pushed, rolled, rotated or pulled in the direction D to have floor seated toilet TB further rotate R with tote assembly 10, shown with tote and toilet rotated R approximately ninety degrees. Preferably tote assembly 10 is positioned on third edge 23 of tote assembly 10 and floor seated toilet TB is positioned on toilet bowl curvature TBC. It is recognized herein that one or more straps may be utilized to push, roll, rotate R or pull tote assembly 10 and floor seated toilet TB in the direction D. It is further recognized herein that one or more straps, specifically third constricting strap 42C may be utilized to elevate third edge 23, specifically where third edge 23 and fourth edge 24/fifth edge 25 of opening 16 connect. Lifting of third constricting strap 42C in direction D and/or the curvature of third edge 23 of tote assembly 10 are configured to prevent residual water or other fluid, such as toilet bowl water W contained therein floor seated toilet TB from spilling or escaping tote assembly 10.

It is contemplated herein that floor seated toilet TB preferably maintains contact being with the floor, and the floor continuously supports floor seated toilet TB.

It is further contemplated herein that angled, curved, or arced first edge 21 and/or third edge 23 preferably provides a raised portion or section to first edge 21 and/or third edge 23 higher than the front rim or toilet bowl curve TBC and when tote assembly 10 is rotated fluid will be contained therein tote assembly 10, and thus enables toilet bowl water W left in floor seated toilet TB to be contained within tote assembly 10 during the inversion to the up righting of opening 16 of tote assembly 10.

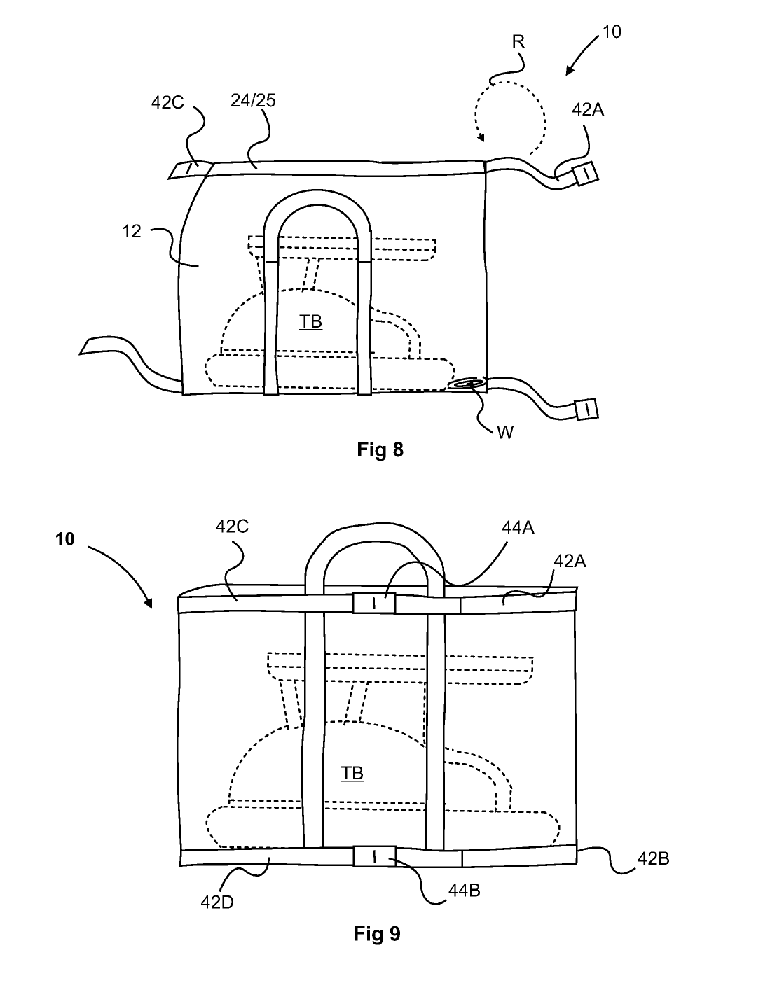

Referring now to FIG. 8, by way of example, and not limitation, there is illustrated exemplary tote assembly 10 shown with floor seated toilet TB positioned therein. Preferably tote assembly 10 is positioned on second edge 22 of tote assembly 10 with opening 16 directed up and floor seated toilet TB is positioned upside down rotated approximately one-hundred and eighty degrees. Furthermore, opening 16 is preferably closed by bringing fourth edge 24 and fifth edge 25 together. Still further, fourth edge 24 and fifth edge 25 are preferably rotated R or rolled or folded over repeatedly to seal opening 16 to create a seal or water tight seam between fourth edge 24 and fifth edge 25. It is further contemplated herein that other sealing mechanisms to seal or create a water tight seam between fourth edge 24 and fifth edge 25 of tote assembly 10 known to one of ordinary skill in the art such as, zip lock, hook and loop, zipper, peel and stick and the like are contemplated herein.

It is recognized herein that floor seated toilet TB at no point has been lifted completely off the floor and now is safely resting on the large flat rim of floor seated toilet TB and contained within water tight seam between fourth edge 24 and fifth edge 25 of tote assembly 10.

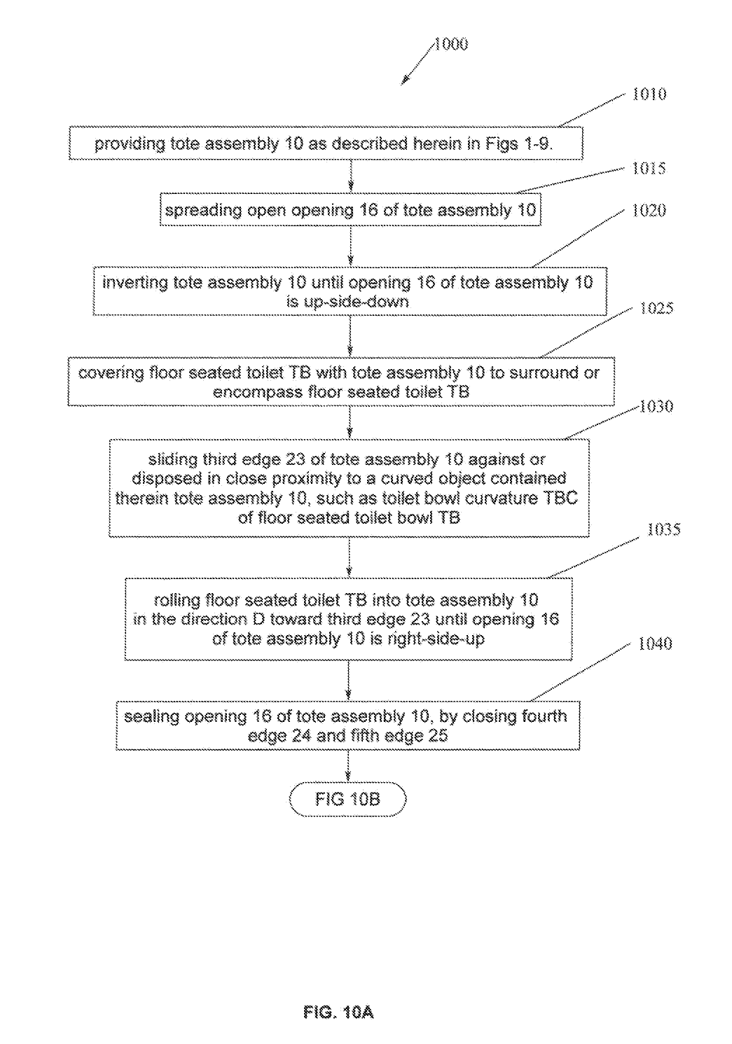

Referring now to FIG. 9, by way of example, and not limitation, there is illustrated exemplary tote assembly 10 shown with floor seated toilet TB positioned therein. Preferably third constricting strap 42C and first constricting strap 42A are affixed together by first attachment mechanism 44A to cinch and constrict rolled fourth edge 24 and fifth edge 25 to seal opening 16 and create a seal or water tight seam between fourth edge 24 and fifth edge 25. Furthermore, fourth constricting strap 42D and second constricting strap 42B are affixed together by second attachment mechanism 44B to cinch and constrict floor seated toilet TB. It is recognized herein that fourth constricting strap 42D and second constricting strap are affixed together by second attachment mechanism 44B to secure floor seated toilet TB between front loop strap 32A and back loop strap 32B or to center the load or contents of tote assembly 10 between first edge 21 and third edge 23 to evenly distribute the contents or load of tote assembly 10, such as floor seated toilet TB. Opening 16 is preferably sealed to prevent the spillage of toilet bowl water W from tote assembly 10.

It is contemplated herein that constricting straps 42 may affix to front layer 12 and back layer 14, such as by hook and loop or peel and stick.

It is further contemplated herein that front layer 12 and back layer 14 may affix to itself, such as by hook and loop or peel and stick.

Moreover, front loop strap 32A and back loop strap 32B preferably extend above constricted tote assembly 10 to enable a user to safely lift, maneuver, transport, and remove a decommissioned floor seated toilet TB from a premise, such as homes, apartments, buildings, and businesses without spilling the contents of the bowl or causing injury.

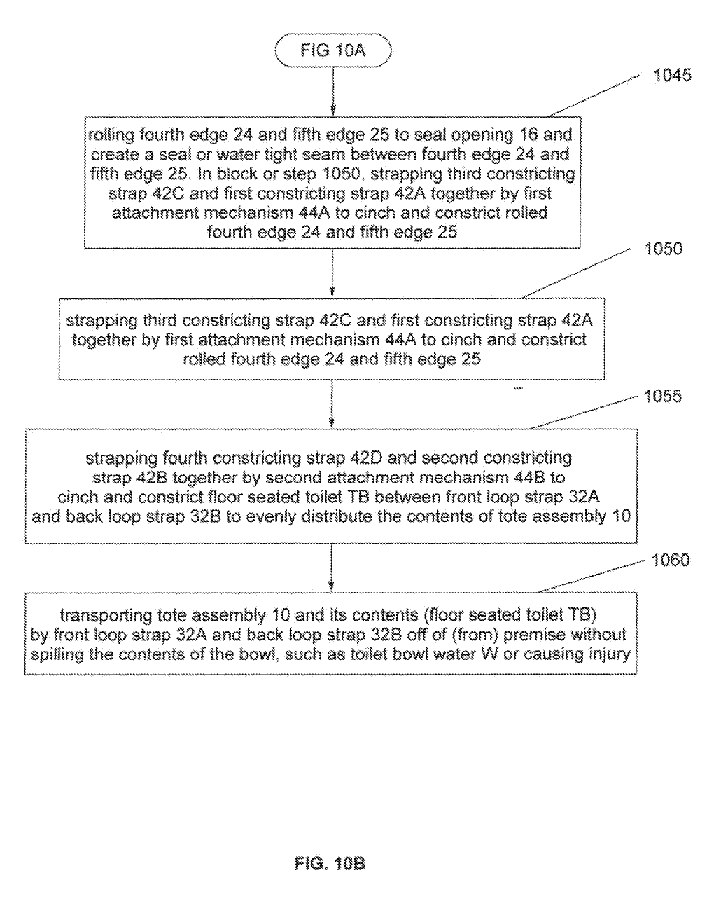

Referring now to FIGS. 10A and 10B, there is illustrated a flow diagram 1000 of a method for removing decommissioned floor seated toilet TB from a premise. In block or step 1010, providing tote assembly 10 as described herein in FIGS. 1-9. In block or step 1015, spreading opening 16 of tote assembly 10. In block or step 1015, inverting tote assembly 10 until opening 16 of tote assembly 10 is up-side-down. In block or step 1025, covering floor seated toilet TB with tote assembly 10 to surround or encompass floor seated toilet TB without having to lift or move floor seated toilet TB. In block or step 1030, sliding third edge 23 of tote assembly 10 against, tucked, or disposed in close proximity to a curved object contained therein tote assembly 10, such as toilet bowl curvature TBC of floor seated toilet bowl TB. In block or step 1035, rolling floor seated toilet TB into tote assembly 10 in the direction D toward third edge 23 until opening 16 of tote assembly 10 is right-side-up. Moreover, grasping the back of floor seated toilet TB, pulling floor seated toilet TB forward, breaking the wax seal while maintaining contact between the front edge or toilet bowl curve TBC and the floor so as to support floor seated toilet TB. In block or step 1040, sealing opening 16 of tote assembly 10, by closing fourth edge 24 and fifth edge 25. In block or step 1045, rolling fourth edge 24 and fifth edge 25 to seal opening 16 and create a seal or water tight seam between fourth edge 24 and fifth edge 25. In block or step 1050, strapping/cinching third constricting strap 42C and first constricting strap 42A together by first attachment mechanism 44A to cinch and constrict rolled fourth edge 24 and fifth edge 25 to seal opening 16. In block or step 1055, strapping/cinching fourth constricting strap 42D and second constricting strap 42B together by second attachment mechanism 44B to cinch and constrict floor seated toilet TB between front loop strap 32A and back loop strap 32B or to center the load or contents of tote assembly 10 between first edge 21 and third edge 23 to evenly distribute the contents or load of tote assembly 10. In block or step 1060, transporting tote assembly 10 and its contents (floor seated toilet TB) by front loop strap 32A and back loop strap 32B off of premise without spilling the contents of the bowl, such as toilet bowl water W or causing injury.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A tote assembly to remove a decommissioned curved article holding fluid therein from a premise, the assembly comprising:
one or more layers having one or more edges, wherein said one or more edges form an opening and wherein said one or more layers and said opening form an interior space, and wherein at least one of said one or more edges is further configured as an arc to match the curvature of the decommissioned curved article holding fluid therein;
one or more lift devices disposed proximate said one or more layers and configured to transport the tote assembly from the premise; and
one or more constricting straps disposed proximate said one or more edges and configured to cinch decommissioned curved article.

2. The tote assembly of claim 1, wherein said one or more layers further comprises a front layer and a back layer.

3. The tote assembly of claim 2, wherein said front layer and said back layer further comprise one or more edges.

4. The tote assembly of claim 3, wherein said one or more edges of said front layer and said one or more edges of said back layer are affixed along said one or more edges shared therebetween.

5. The tote assembly of claim 4, wherein said one or more edges are sealed to form a water tight seam.

6. The tote assembly of claim 5, wherein said one or more lift devices further comprises one or more loop straps.

7. The tote assembly of claim 6, wherein said one or more loop straps further comprises a front loop strap affixed thereto said front layer and a back loop strap affixed thereto said back layer.

8. The tote assembly of claim 6, wherein said one or more loop straps further comprises a continuous loop.

9. The tote assembly of claim 7, wherein said one or more constricting straps disposed proximate said one or more edges configured to distribute decommissioned curved article therebetween said one or more edges.

10. The tote assembly of claim 1, further comprising a sealing mechanism between said one or more edges that form said opening, said sealing mechanism configured to contain the fluid and the decommissioned curved article holding fluid.

11. A tote assembly to remove a decommissioned curved article holding fluid therein from a premise, the assembly comprising:
one or more layers, said one or more layers having a front layer and a back layer, wherein said front layer and said back layer further comprise one or more edges to form an opening and wherein said one or more layers and said opening form an interior space, and wherein at least one of said one or more edges is further configured as an arc to match the curvature of the decommissioned curved article holding fluid therein;
one or more lift devices disposed proximate said one or more layers and configured to transport the tote assembly from the premise, said one or more lift devices further comprises one or more loop straps; and
one or more constricting straps disposed proximate said one or more edges and configured to cinch decommissioned curved article, said one or more constricting straps configured to distribute decommissioned curved article therebetween said one or more edges.

12. A method of removing a decommissioned curved article holding fluid therein from a premise, comprising the steps of:
providing a tote assembly having one or more layers, said one or more layers having a front layer and a back layer, wherein said front layer and said back layer further comprise one or more edges to form an opening and wherein said one or more layers and said opening form an interior space, and wherein at least one of said one or more edges is further configured as an arc to match the curvature of the decommissioned curved article holding fluid therein, one or more lift devices disposed proximate said one or more layers and configured to transport the tote assembly from the premise, said one or more lift devices further comprises one or more loop straps, and
one or more constricting straps disposed proximate said one or more edges and configured to cinch decommissioned curved article, said one or more constricting straps configured to distribute decommissioned curved article therebetween said one or more edges;
spreading open said opening;
inverting said opening up-side-down;
covering the decommissioned curved article holding fluid therein;
sliding said at least one of said one or more edges configured as an arc against the decommissioned curved article holding fluid therein; and
rolling said tote assembly and the decommissioned curved article holding fluid therein toward said at least one of said one or more edges configured as an arc until said opening is right-side-up.

13. The method of claim 12, further comprising the step of sealing said opening.

14. The method of claim 13, further comprising the step of cinching said one or more constricting straps to constrict decommissioned curved article holding fluid therein between said one or more edges.

15. The method of claim 14, transporting said tote assembly and decommissioned curved article holding fluid therein from the premise.
